(19) United States
(12) Patent Application Publication
(10) Pub. No.: US 2014/0104893 A1
(43) Pub. Date: Apr. 17, 2014

(54) ISOLATED INTERLEAVED DC CONVERTER

(71) Applicant: NATIONAL TSING HUA UNIVERSITY, Hsinchu City (TW)

(72) Inventors: Ching-Tsai Pan, Hsinchu City (TW); Po-Yen Chen, Taipei (TW); Ming-Chieh Cheng, Taipei (TW); Ching-Hsiang Cheng, Chiayi City (TW)

(73) Assignee: National Tsing Hua University, Hsinchu City (TW)

(21) Appl. No.: 13/686,023

(22) Filed: Nov. 27, 2012

(30) Foreign Application Priority Data
Oct. 12, 2012 (TW) 101137855

(51) Int. Cl. H02M 3/335

(52) U.S. Cl. CPC H02M 3/335
USPC 363/21.02

(57) ABSTRACT

An isolated interleaved DC converter has a main circuit architecture integrating a transformer, a dual-phase interleaved step-up circuit, a voltage type auto charge pump circuit with a double-voltage rectifier circuit. The circuit of the invention integrates with the transformer, and combines the dual-phase interleaved boost circuit and the voltage type auto charge pump circuit at a primary side of the transformer to reduce the input current ripple. At a secondary side of the transformer, the circuit of the invention further combines the double-voltage rectifier circuit. The active switching elements can be further integrated in the dual-phase interleaved boost circuit to realize the soft switching technology while reducing EMI and the switching loss and increasing the circuit conversion efficiency.

### BACKGROUND OF THE INVENTION

1. Field of the Invention

The present invention relates to an isolated interleaved DC converter, and particularly to a DC converter which has an integrated soft switching technology with high voltage conversion. More particularly, the present invention relates to a converter circuit which integrates a transformer, combines a voltage type auto charge pump circuit with a dual-phase interleaved boost circuit at a primary side of the transformer, and grants the circuit with characteristics of variable circuit architecture and soft switching effect for switching elements by the design of circuit parameters and the action of the LC resonant circuit.

2. Description of Related Art

A double-voltage circuit is mainly constituted by a diode and a capacitor. Its action is to output a rectified voltage peak value after magnitude, and it is often used to applications which need high voltage and low current. FIG. 7 shows that a dual-phase interleaved double-voltage converter circuit mainly consists of two sets of dual-phase interleaved boost converter circuits 4 operating with phase difference of 180 degrees in cooperation with a double-voltage rectifier circuit 5. Because two sets of inductor currents have high frequency ripple components in mutually interleaved form, they can offset each other to reduce the high frequency ripple of the input current caused by switching. The circuit elements can share the current, and thus improve the efficiency while reducing the energy storage inductor's volume and the costs. The interleaved switching technology, usually called ripple cancellation, contributes to the ripple reduction. However, strictly speaking, only when the converter is operating at duty cycle of 50%, the high-frequency ripple at peak-to-peak value can be fully offset. When the converter is operating at duty cycle of rather than 50%, the high-frequency ripple can be reduced by overlapping individual current ripples to achieve the effect of partial offset.

In recent years, due to the global energy shortage and the impact of the greenhouse effect, the countries in the world actively promote the development of decentralized clean energy, such as photovoltaic systems and fuel cells. However, the photovoltaic systems and the fuel cells have low output voltage, and therefore rely on high step-up ratio power converters to increase the output voltage for back-end applications.

Currently available dual-phase interleaved double-voltage converters usually achieve the purpose of reducing the cost of components and the volume of the converter by means of increasing the switching frequency to cut down the capacitance value and a magnetic element's volume in order to increase the power density of the converter. However, while enhancing the switching frequency of the conversion circuit, the switching loss of the switching elements increases accordingly. Problems such as electric magnetic interruption (EMI) occur as well. Therefore, the conventional converter circuit cannot meet the need for users in actual use any more.

### SUMMARY OF THE INVENTION

A main purpose of this invention is to overcome the shortcomings of conventional technology, and provide a DC converter which has an integrated soft switching technology with high voltage conversion. The converter of this invention integrates a transformer, and combines a voltage type auto charge pump circuit with a dual-phase interleaved boost circuit at a primary side of the transformer. The design of circuit parameters and the action of the LC resonant circuit grant the circuit of the invention with characteristics of variable circuit architecture and achieve the soft switching effect for switching elements.

It is another purpose of this invention to provide a converter circuit which combines a double-voltage rectifier circuit at a secondary side of a transformer to further enhance the output voltage, and further integrates switching elements of the dual-phase interleaved boost circuit with the use characteristics of automatically changing the circuit architecture so as to realize the soft switching while reducing electric magnetic interruption (EMI) and the switching losses and increasing circuit conversion efficiency.

It is still purpose of the invention to provide a converter circuit having low output voltage ripple and able to avoid using large-capacitance electrolytic capacitors and extending the service life of the transformer, so as to achieve high power density, high voltage conversion ratio, low costs, low electric magnetic interruption (EMI), low output voltage ripple, long service life and high conversion efficiency.

It is still another purpose of the invention to provide a converter circuit having advantages of high step-up ratio, low cost, low EMI, low input current ripple, high conversion efficiency and soft switching effect for the switching elements.

In order to achieve the above and other objectives, an isolated interleaved DC converter of the invention includes:
a front-end conversion circuit, including a dual-phase interleaved boost circuit and a voltage-type auto charge pump circuit, wherein the dual-phase interleaved boost circuit is provided with a negative voltage terminal at an input side respectively coupling to a first active switching element and a second active switching element in parallel, a positive voltage terminal at the input side respectively coupling to a first inductor and a second inductor in parallel, and wherein the first active switching element and the first inductor which is coupled to the first active switching element in series are coupled in series to a semi-resonant circuit of the voltage-type auto charge pump circuit; the semi-resonant circuit is coupled to one common node between the first active switching element and the first inductor and includes a third inductor and a first capacitor coupled to the third inductor in parallel; the voltage-type auto charge pump circuit further includes a second capacitor coupled in series to the semi-resonant circuit; and the second capacitor is coupled in parallel to a common node between the second active switching element and the second inductor; and
a transformer, wherein a primary side of the transformer is coupled to the front-end conversion circuit and to the second capacitor in parallel, a secondary side of the transformer is coupled to a rear-end conversion circuit which is electrically coupled with the front-end conversion circuit through the transformer.

In one embodiment, the secondary side of the transformer is coupled with the rear-end conversion circuit which is a full-bridge rectifier circuit constituted by four diodes and a capacitor.

In one embodiment, the secondary side of the transformer is coupled with the rear-end conversion circuit which is a double-voltage rectifier circuit constituted by two diodes and two capacitors.

In one embodiment, the transformer is a multi-winding transformer, and the secondary side of the transformer is coupled with the rear-end conversion circuit which is a rectifier circuit constituted by two diodes and one capacitor.

In one embodiment, the transformer is a multi-winding transformer, and the secondary side of the transformer is coupled with the rear-end conversion circuit which is a triple-voltage rectifier circuit constituted by four diodes and three capacitors.

In one embodiment, the transformer is a multi-winding transformer, and the secondary side of the transformer is coupled with the rear-end conversion circuit which is a four times-voltage rectifier circuit constituted by four diodes and four capacitors.

In one embodiment, the transformer is a multi-winding transformer, and the secondary side of the transformer is coupled with the rear-end conversion circuit which is a five times-voltage rectifier circuit constituted by six diodes and five capacitors.

In one embodiment, the transformer is a multi-winding transformer, and the secondary side of the transformer is coupled with the rear-end conversion circuit which is a six times-voltage rectifier circuit constituted by six diodes and six capacitors.

### BRIEF DESCRIPTION OF THE DRAWINGS

FIG. 1A is a schematic diagram of a full-bridge rectifier circuit at a secondary side of a transformer of an isolated interleaved DC converter circuit according to the invention.

FIG. 1B is a schematic diagram of a double-voltage rectifier circuit at a secondary side of a transformer of an isolated interleaved DC converter circuit according to the invention.

FIG. 1C is a schematic diagram of a rectifier circuit at a secondary side of a transformer of an isolated interleaved DC converter circuit according to the invention.

FIG. 1D is a schematic diagram of a triple-voltage rectifier circuit at a secondary side of a transformer of an isolated interleaved DC converter circuit according to the invention.

FIG. 1E is a schematic diagram of a four times-voltage rectifier circuit at a secondary side of a transformer of an isolated interleaved DC converter circuit.

FIG. 1F is a schematic diagram of a five times-voltage rectifier circuit at a secondary side of a transformer of an isolated interleaved DC converter circuit according to the invention.

FIG. 1G is a schematic diagram of a six times-voltage rectifier circuit at a secondary side of a transformer of an isolated interleaved DC converter circuit according to the invention.

FIG. 2 is a schematic diagram of an equivalent circuit of an isolated interleaved DC converter in the Working Mode 1 according to the present invention.

FIG. 3 is a schematic diagram of an equivalent circuit of an isolated interleaved DC converter in the Working Mode 2 according to the present invention.

FIG. 4 is a schematic diagram of an equivalent circuit of an isolated interleaved DC converter in the Working Mode 3 according to the present invention.

FIG. 5 is a schematic diagram of an equivalent circuit of an isolated interleaved DC converter in the Working Mode 4 according to the present invention.

FIG. 6 is a schematic diagram of a simulated waveform 1 for V_{C1}, i_{L1}, i_{L2}, V_{OA}, i_{M1}, i_{M2}, PWM1 and PWM2 signals of an isolated interleaved DC converter according to the present invention.

FIG. 7 is a schematic diagram of a conventional dual-phase interleaved double-voltage converter circuit.

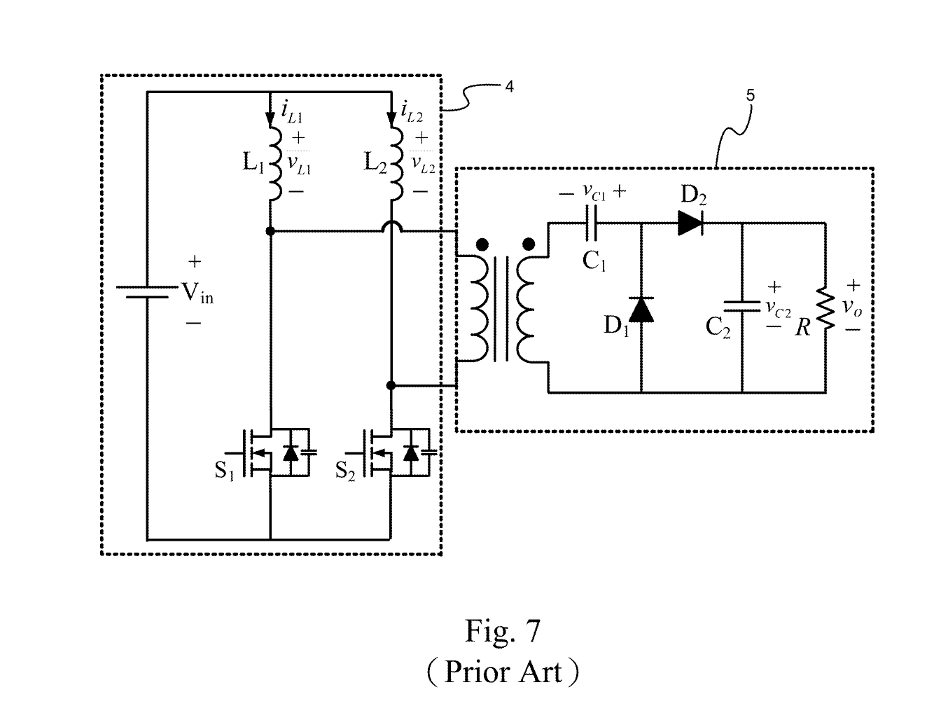

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

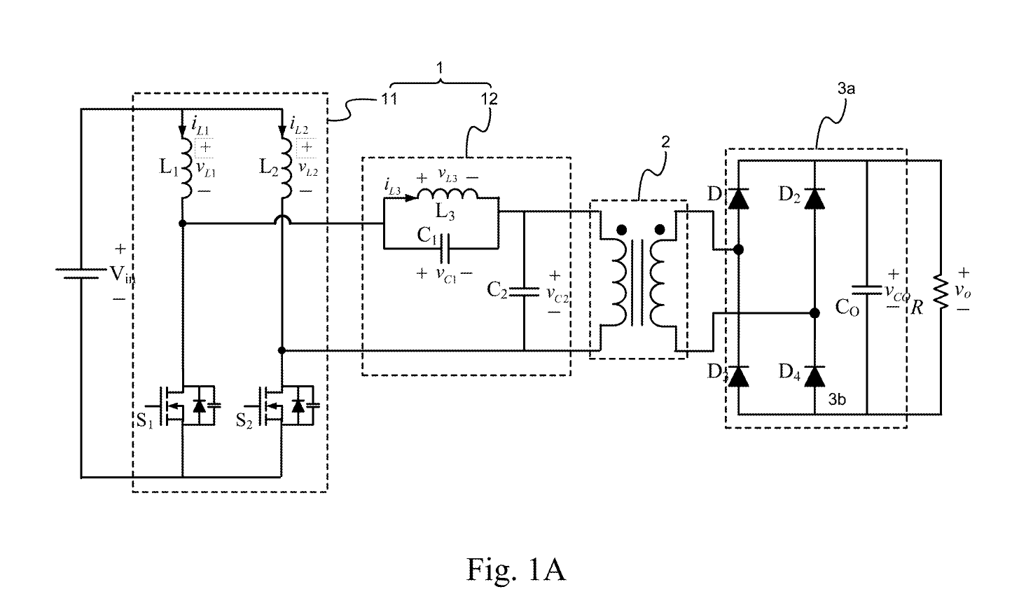

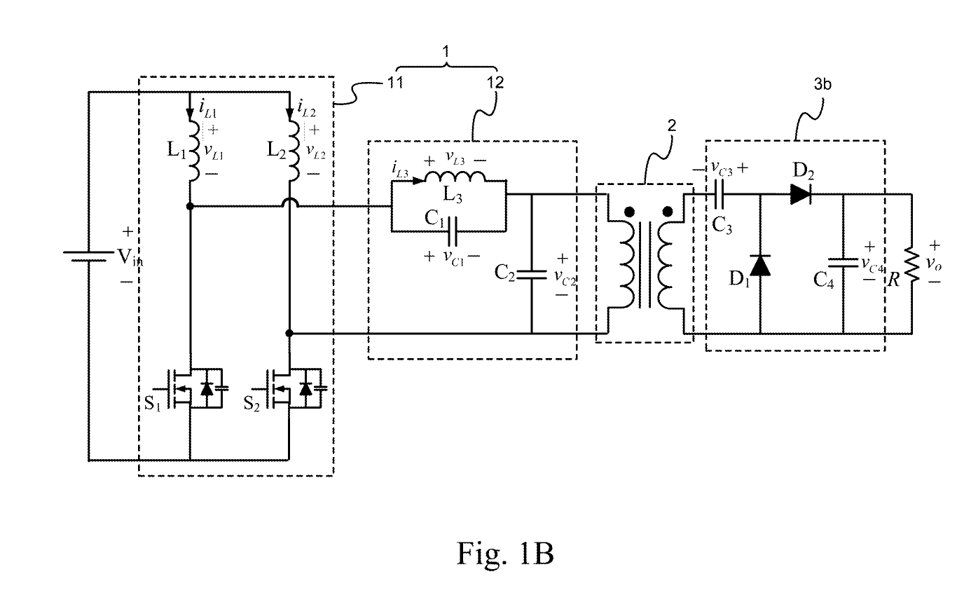

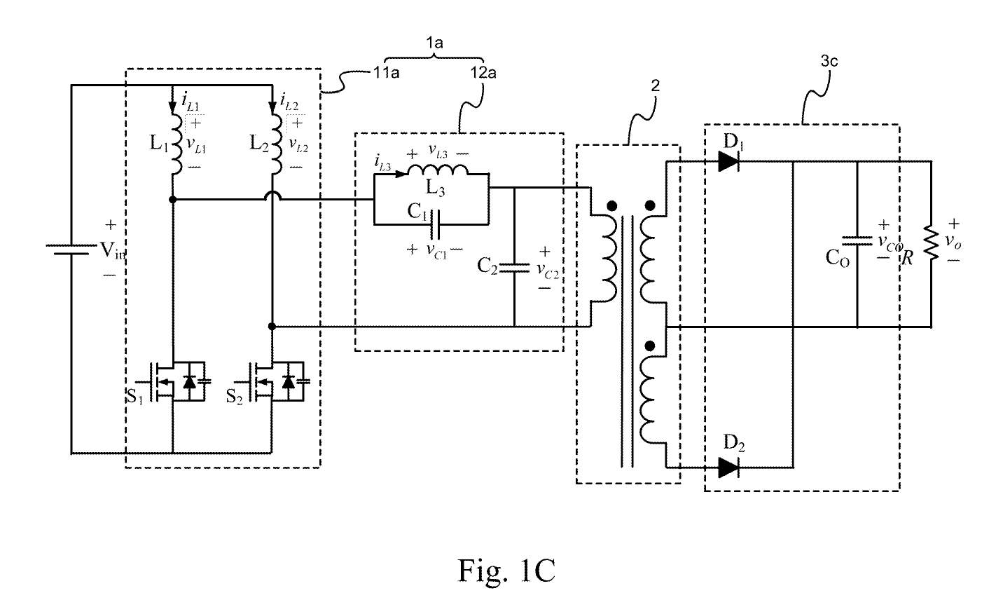

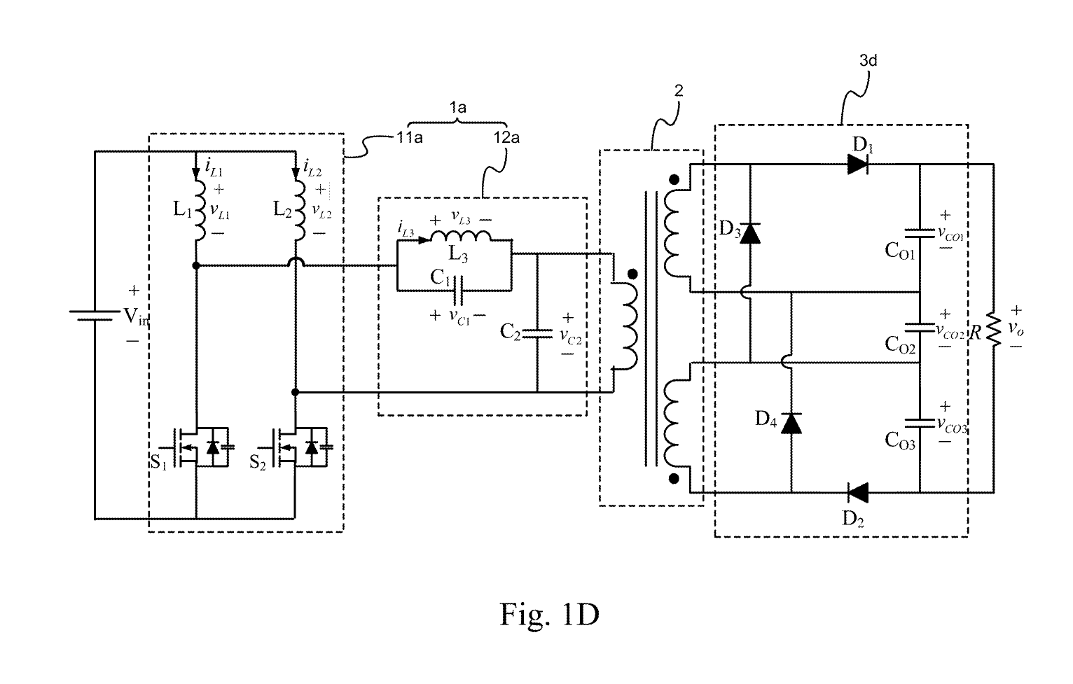

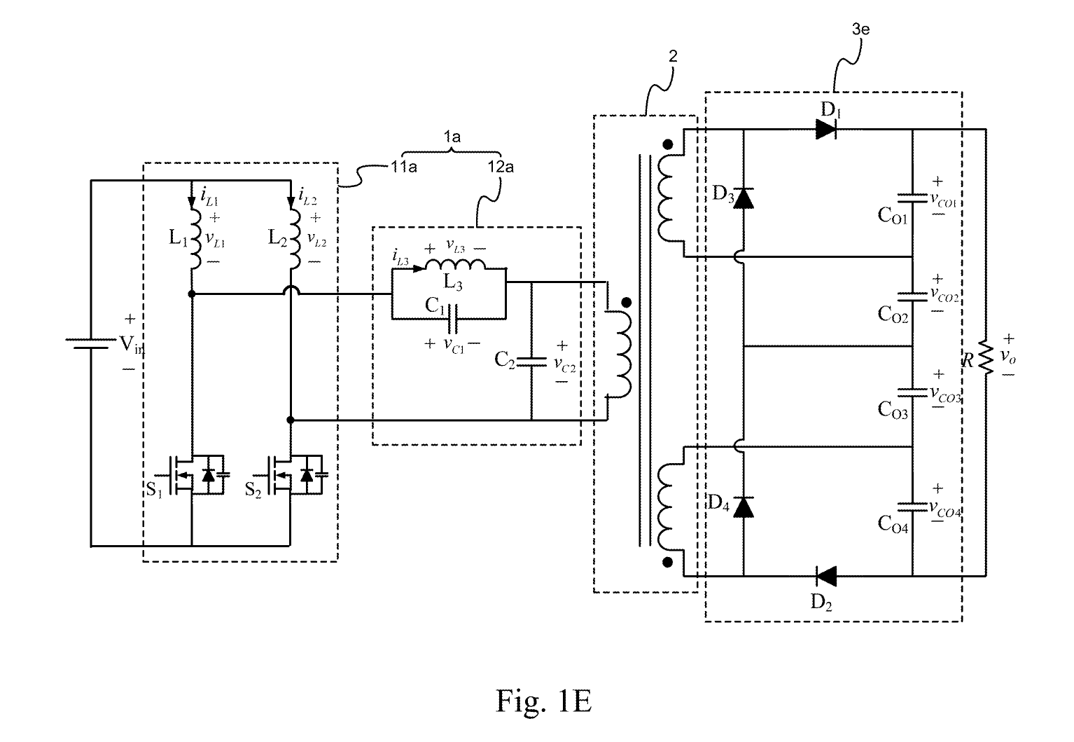

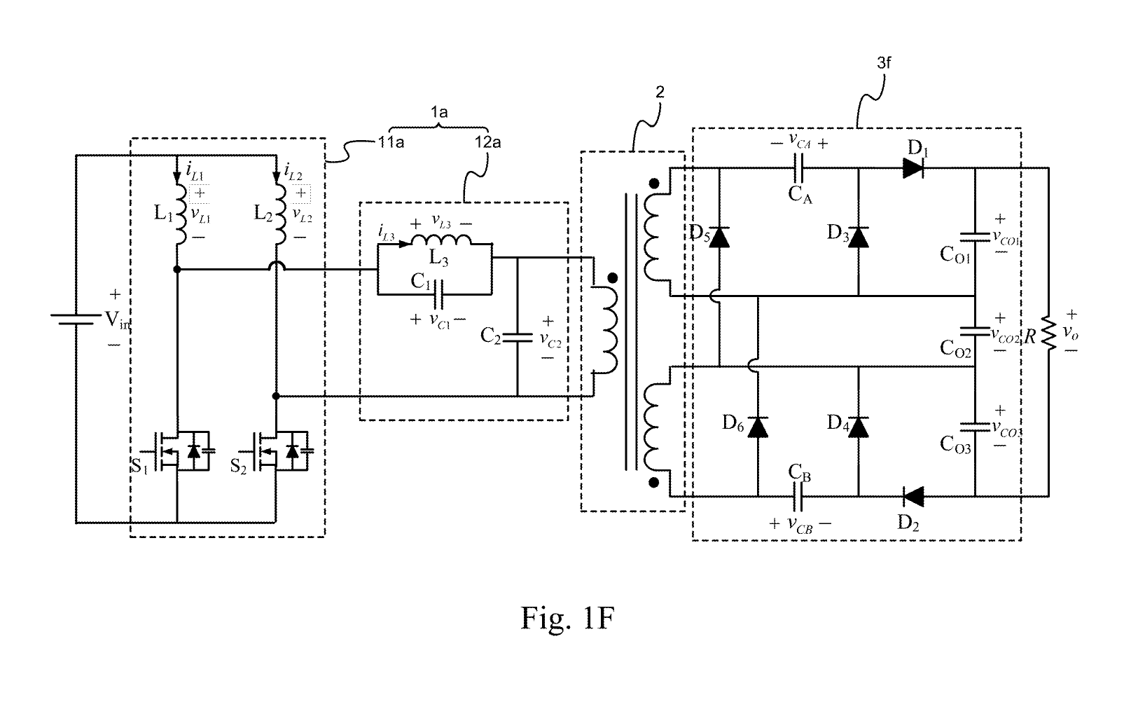

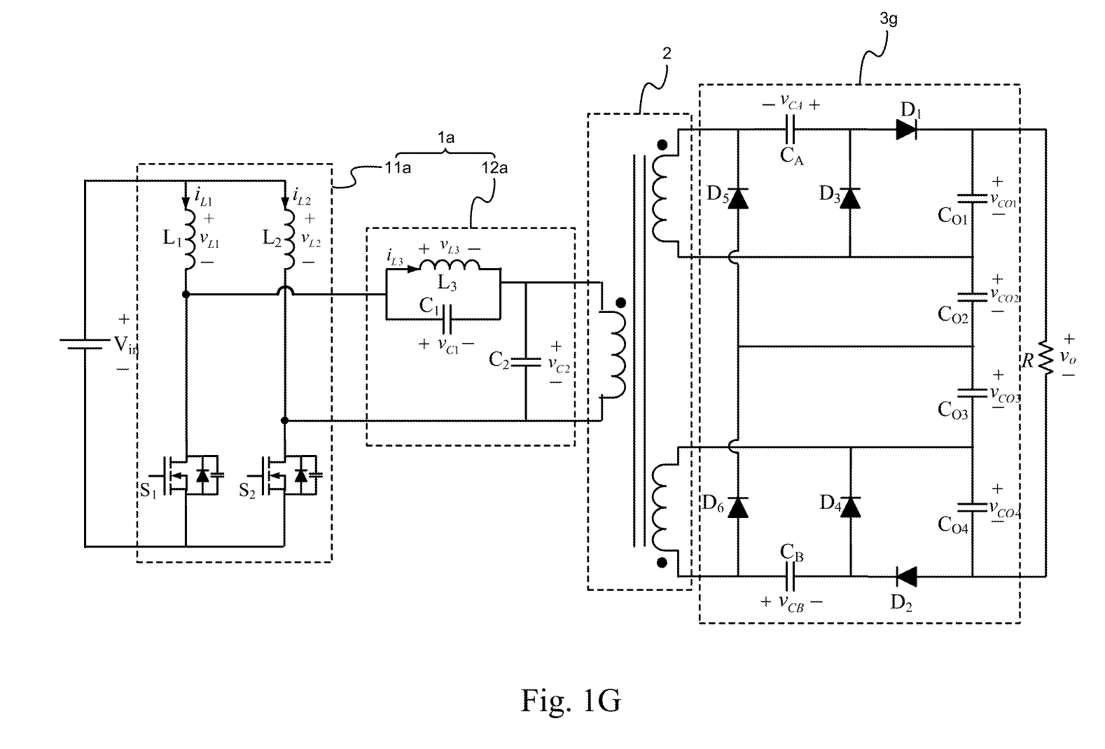

FIG. 1A through FIG. 1G are respectively a schematic diagram of a full-bridge rectifier circuit at a secondary side of a transformer of an isolated interleaved DC converter circuit, a schematic diagram of a double-voltage rectifier circuit at a secondary side of a transformer of an isolated interleaved DC converter circuit, a schematic diagram of a rectifier circuit at a secondary side of a transformer of an isolated interleaved DC converter circuit, a schematic diagram of a triple-voltage rectifier circuit at a secondary side of a transformer of an isolated interleaved DC converter circuit, a schematic diagram of a four times-voltage rectifier circuit at a secondary side of a transformer of an isolated interleaved DC converter circuit, a schematic diagram of a five times-voltage rectifier circuit at a secondary side of a transformer of an isolated interleaved DC converter circuit, and a schematic diagram of a six times-voltage rectifier circuit at a secondary side of a transformer of an isolated interleaved DC converter circuit, according to the invention. As shown, the isolated interleaved DC converter circuit according to the invention includes at least a front-end conversion circuit 1 and a transformer 2 or 2a.

The front-end conversion circuit 1 includes a dual-phase interleaved boost circuit 11 and a voltage-type auto charge pump circuit 12. The dual-phase interleaved boost circuit 11 is provided with a negative voltage terminal at an input side respectively coupling to a first active switching element S1 and a second active switching element S2 in parallel, and a positive voltage terminal at the input side respectively coupling to a first inductor L1 and a second inductor L2 in parallel. The first active switching element S1 and the first inductor L1 which is coupled in series to the first active switching element S1 are coupled in series to a semi-resonant circuit of the voltage-type auto charge pump circuit 12. The semi-resonant circuit is coupled to one common node between the first active switching element S1 and the first inductor L1 and includes a third inductor L3 and a first capacitor C1 coupled to the third inductor L3 in parallel. The voltage-type auto charge pump circuit 12 further includes a second capacitor C2 coupled in series to the semi-resonant circuit. The second capacitor C2 is coupled in parallel to a common node between the second active switching element S2 and the second inductor L2.

A primary side of the transformer 2 or 2a is coupled to the front-end conversion circuit 1, and is coupled with the second capacitor C2 in parallel. A secondary side of the transformer 2 or 2a is coupled to a rear-end conversion circuit which is electrically coupled with the front-end conversion circuit 1 via the transformer 2 or 2a. In this way, a new isolated interleaved DC converter is accomplished.

The secondary side of the above transformer 2 is coupled with the rear-end conversion circuit which is a full-bridge rectifier circuit 3a constituted by four diodes D₁, D₂, D₃, D₄ and a capacitor C₀, as shown in FIG. 1A.

The secondary side of the above transformer 2 is coupled with the rear-end conversion circuit which is a double-voltage rectifier circuit 3b constituted by two diodes D₁, D₂ and two capacitors C₃, C₄, as shown in FIG. 1B.

The above transformer is a multi-winding transformer 2a and the secondary side thereof is coupled with the rear-end conversion circuit which is a rectifier circuit 3c constituted by two diodes D₁, D₂ and a capacitor C₀, as shown in FIG. 1C.

The above transformer is a multi-winding transformer 2a and the secondary side thereof is coupled with the rear-end conversion circuit which is a triple-voltage rectifier circuit 3d constituted by four diodes D₁, D₂, D₃, D₄ and three capacitors C₀₁, C₀₂, C₀₃, as shown in FIG. 1D.

The above transformer is a multi-winding transformer 2a and the secondary side thereof is coupled with the rear-end conversion circuit which is a four times-voltage rectifier circuit 3e constituted by four diodes D₁, D₂, D₃, D₄ and four capacitors C₀₁, C₀₂, C₀₃, C₀₄, as shown in FIG. 1E.

The above transformer is a multi-winding transformer 2a and the secondary side thereof is coupled with the rear-end conversion circuit which is a five times-voltage rectifier circuit 3f constituted by six diodes D₁, D₂, D₃, D₄, D₅, D₆ and five capacitors C_{A}, C₀₁, C₀₂, C₀₃, C_{B}, as shown in FIG. 1F.

The above transformer is a multi-winding transformer 2a and the secondary side thereof is coupled with the rear-end conversion circuit which is a six times-voltage rectifier circuit 3g constituted by six diodes D₁, D₂, D₃, D₄, D₅, D₆ and six capacitors C_{A}, C₀₁, C₀₂, C₀₃, C₀₄, C_{B}, as shown in FIG. 1G.

In the embodiment of the invention which is exemplified by the isolated interleaved DC converter circuit with the reference to FIG. 1B, the circuit of the invention is based on four capacitors, two active switching elements, three inductors, two diodes and one transformer. Its operation principle is as follows. A semi-resonant circuit is made, along with the design of parameters, based on the configuration that the third inductor L3 is coupled in parallel to the first capacitor C1. Then the semi-resonant circuit is coupled to the second capacitor C2 in series to achieve the effect of dividing pressure. When the capacitance value of the second capacitor C2 is similar to that of the first capacitor C1, the energy of the power input will be stored respectively in the semi-resonant circuit constituted by the first capacitor C1 and the third inductor L3, and in the second capacitor C2. As an across voltage of the first capacitor C1 rapid arises, the energy stored in the first capacitor C1 is converted into an inductor current i_{L3}, while the polarity of the across voltage of the first capacitor C1 is inverted. In cooperation with the input power and a booster circuit constituted by the energy storage inductor L1 or the second inductor L2, the input energy is conveyed to the second capacitor C2 to constitute an in-series resonant in-parallel load circuit. Furthermore, after enhancing the across voltage of the second capacitor C2, the energy is conveyed to a secondary side of a double-voltage circuit via the transformer, so that the circuit architecture is changed after an intrinsic diode of an open circuit active switching element is turned on to achieve the soft switching. In FIG. 1B, the circuit at the secondary side of the transformer is a double-voltage rectifier circuit for the purpose of exemplification, but it does not intend to limit the circuit of the invention to this example. Other rectifier circuits as shown in the series of FIG. 1A and FIG. 1C˜FIG. 1G can be used as well.

The action of the dual-phase interleaved circuit can reduce the input ripple. The double-voltage rectifier circuit at the secondary side of the transformer can be a conventional boost circuit. The circuit of the invention adds a voltage-type auto charge pump circuit to the primary side of the transformer, effectively increasing the step-up ratio and achieving the effect of soft switching.

The following description is based on the isolated interleaved DC converter circuit of FIG. 1B at the boost mode. In this embodiment, in order that the circuit of the invention can work at the best operation mode, three inductors L1, L2, L3, operating in a manner of continuously conducting the current, are taken as example for illustration. In order to clearly illustrate how the isolated interleaved DC converter circuit of the present invention works, it is assumed that all the circuit elements are ideal, and each of their loads is pure resistance R. The working modes of the isolated interleaved DC converter circuit are described as follows.

### [Working Mode 1]

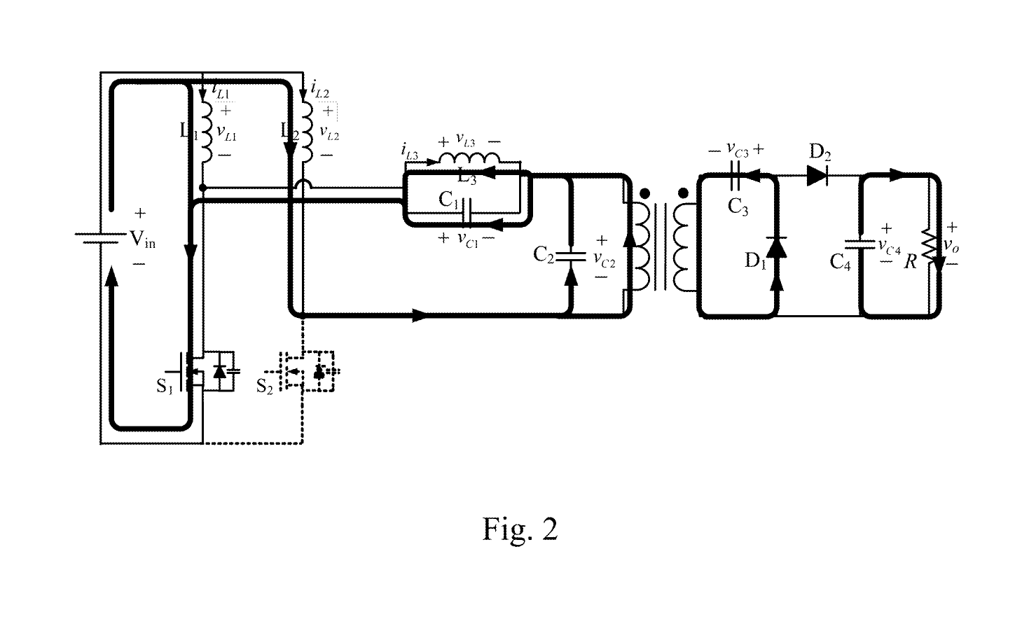

Refer to FIG. 2, which is a schematic diagram of an equivalent circuit of an isolated interleaved DC converter in the Working Mode 1 according to the present invention. As shown, when the first active switching element S1 is turned on while the second active switching element S2 is turned off, the energy storage inductor L1 is charged by the input power supply Vᵢₙ via the first active switching elements S1, while the energy is conveyed to the L3C1 resonant circuit via the second inductor L2. Then, via the transformer and the first diode D1, the third capacitor C3 is charged and the fourth capacitor C4 continues providing the load with the energy. Its equivalent circuit is as shown in FIG. 2. When the intrinsic diode of the second active switching element S2 is turned on, the circuit of the present invention goes to the Working Model 2.

### [Working Mode 2]

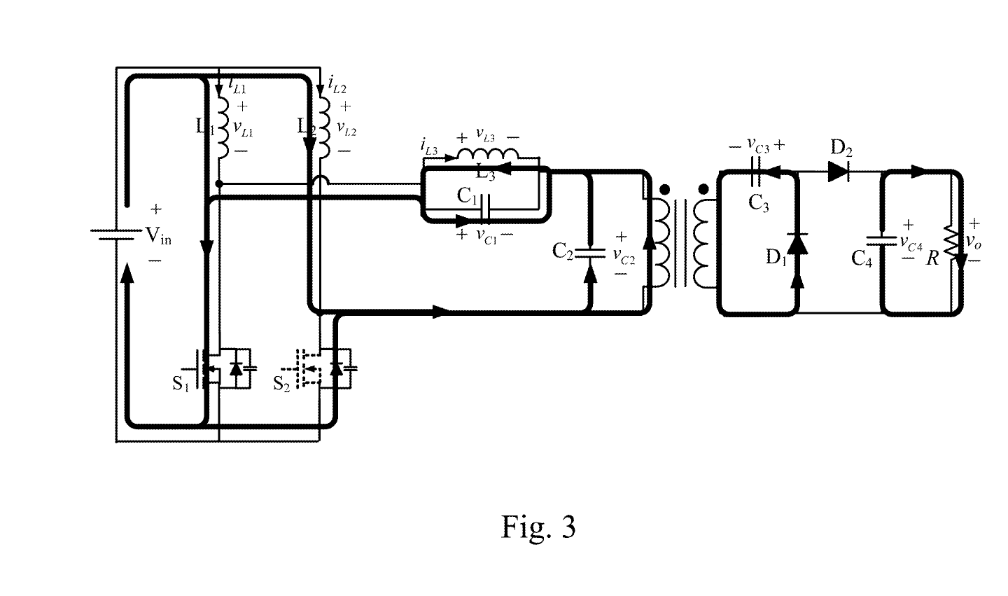

Refer to FIG. 3 which is a schematic diagram of an equivalent circuit of an isolated interleaved DC converter in the Working Mode 2 according to the present invention. As shown, the energy storage inductor L1 is charged by the input power supply Vᵢₙ via the first active switching elements S1. After the energy is conveyed to the L3C1 resonant circuit via the second inductor L2, the stored energy of the first capacitor C1 is converted into the i_{L3} by means of the resonance of the third inductor L3 and the first capacitor C1. The polarity of the across voltage of the first capacitor C1 is inverted. The intrinsic diode of the second active switching element S2 is turned on to change the circuit architecture. The first capacitor C1, the third inductor L3, the first active switching element S1, the second capacitor C2 and the intrinsic diode of the second active switching element S2 constitute a loop. In cooperation of the transformer, the stored energy is conveyed to the secondary side of the transformer. The third capacitor C3 is charged by a first diode D1. The fourth capacitor C4 continues providing the energy to the load. Its equivalent circuit is shown in FIG. 3. When the second active switching element S2 is turned on, the circuit of the present invention goes into the Working Mode 3.

### [Working Mode 3]

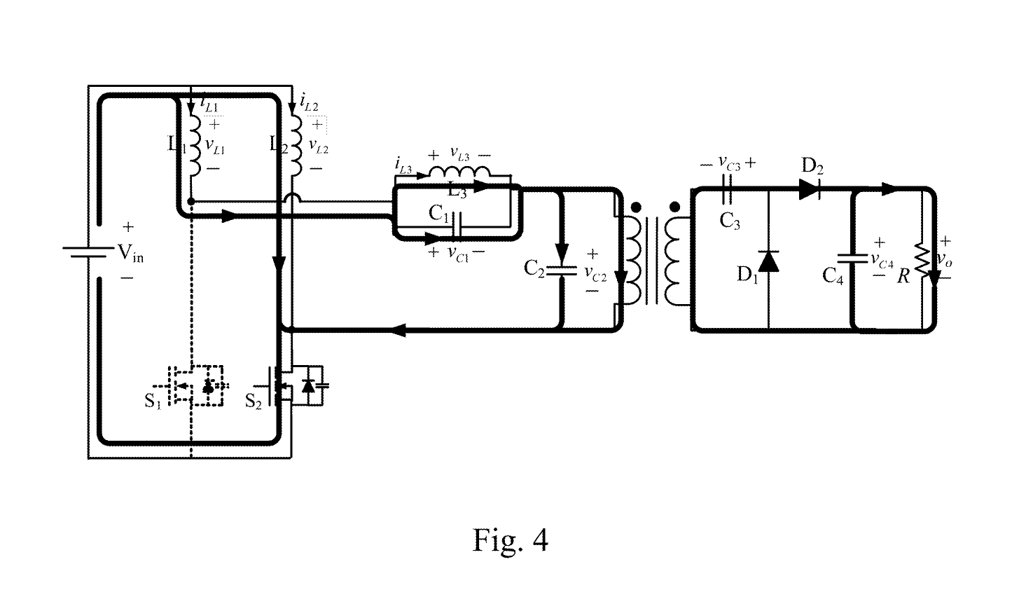

Refer to FIG. 4 which is a schematic diagram of an equivalent circuit of an isolated interleaved DC converter in the Working Mode 3 according to the present invention. As shown, when the first active switching element S1 is turned off while the second active switching element S2 is turned on, the energy storage inductor L2 is charged by the input power supply Vᵢₙ via the second active switching elements S2. After the energy is conveyed to the L3C1 resonant circuit through the first inductor L1, the fourth capacitor C4 is charged by the transformer and the third capacitor 3 via the second diode D2, while providing the load with the energy. Its equivalent circuit is as shown in FIG. 4. When the intrinsic diode of the first active switching elements S1 is turned on, the circuit of the present invention goes into the Working Mode 4.

### [Work Mode 4]

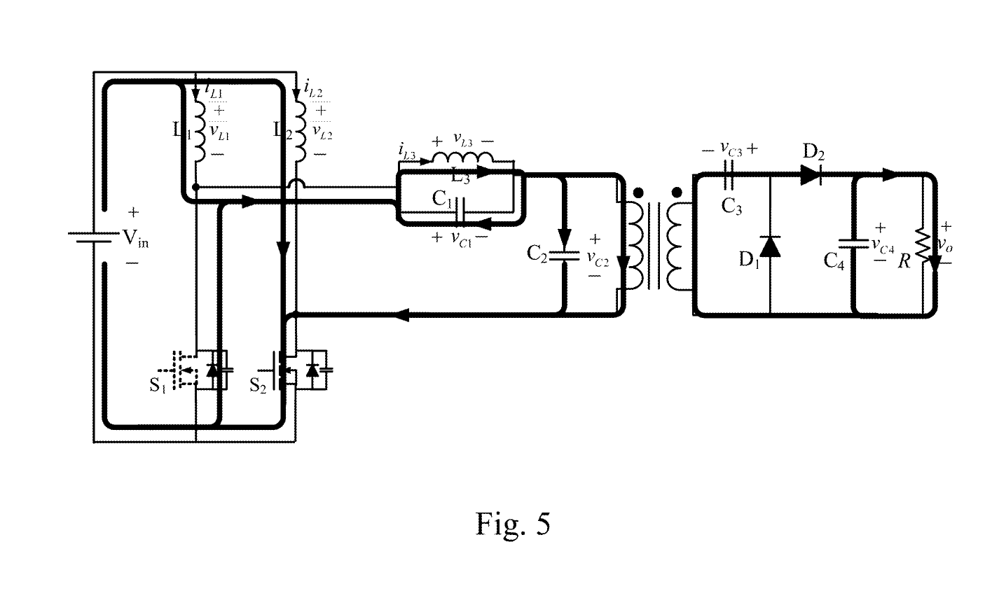

Refer to FIG. 5 which is a schematic diagram of an equivalent circuit of an isolated interleaved DC converter in the Working Mode 4 according to the present invention. As shown, the energy storage inductor L2 is charged by the input power supply Vᵢₙ via the second active switching elements S2. After the energy is conveyed to the L3C1 resonant circuit through the first inductor L1, the stored energy of the first capacitor C1 is converted into the i_{L3} by means of the resonance of the third inductor L3 and the first capacitor C1. The polarity of the across voltage of the first capacitor C1 is inverted. The intrinsic diode of the first active switching element S1 is turned on to change the circuit architecture. The first capacitor C1, the third inductor L3, the second active switching element S2, the second capacitor C2 and the intrinsic diode of the first active switching element S1 constitute a loop. In cooperation of the transformer, the stored energy is conveyed to the secondary side of the transformer. Meanwhile, along with the third capacitor C3, the fourth capacitor C4 is charged by the second diode D2 and continues providing the energy to the load. Its equivalent circuit is shown in FIG. 5. When the first active switching element S1 is turned on and the second active switching element S2 is turned on, the circuit of the present invention goes into the Working Mode 1. Thereby, it finishes the action for one cycle.

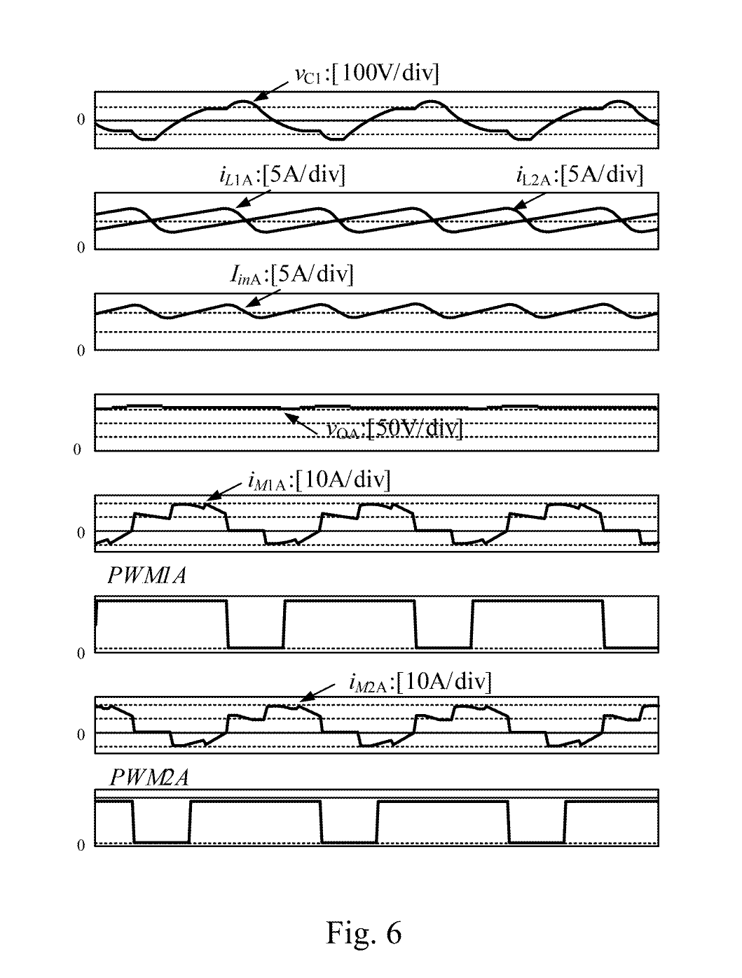

FIG. 6 is a schematic diagram of a simulated waveform 1 for V_{C1}, i_{L1}, i_{L2}, V_{OA}, i_{M1}, i_{M2}, PWM1 and PWM2 signals of an isolated interleaved DC converter according to the present invention. As shown, in order to verify the practicability and progress of the isolated interleaved DC converter according to the present invention, the converter circuit of FIG. 1B is exemplified for illustration. The circuit parameters are respectively shown in Table I. In the case that the transformer is operated at the duty cycle of 0.5, the action of the circuit of the transformer is simulated by circuit simulation software. In the isolated interleaved DC converter of the invention, a controller generates two sets of interleaved with phase difference of 180 degrees to adjust the signals PWM1A and PWM2A as required. The simulation results are shown in FIG. 6. V_{C1} is a capacitor voltage of the first capacitor C1 in the circuit of the present invention. i_{L1} is an inductor current of the first inductor L1 in the circuit according to the present invention. i_{L2} is an inductor current of the second inductor L2 in the circuit according to the present invention. I_{inA} is an input current of the circuit of the present invention. V_{OA} is an output voltage of the circuit of the present invention. i_{M1A}˜i_{M2A} are respectively currents of the first active switching element S1 and the second active switching element S2 in the circuit of the present invention. PWM1 and PWM2 are respectively control signals of the first active switching element S1 and the second active switching element S2 in the circuit of the present invention.

TABLE I

| | Values | |
|---|---|---|
| L1 | 100 | uH |
| L2 | 100 | uH |
| L3 | 10 | uH |
| C1 | 0.1 | uF |
| C2 | 0.2 | uF |
| C3, C4 | 10 | uF |
| Duty cycle | 0.5 | |
| Input voltage | 12 | V |
| Switching frequency | 100 | KHz |
| load resistance | 200 | Ω |

From the simulation results of FIG. 6, it is found that the isolated interleaved DC converter of the invention can obtain higher step-up ratio at conditions of output voltage of 158V and boost ratio of 13.1. From the simulation results of FIG. 6, it can be also found that the isolated interleaved DC converter of the present invention achieves the effect of soft switching for all the switching elements.

In cooperation with the isolated interleaved DC converter circuit of the present invention, the integrated transformer, the dual-phase interleaved boost circuit, the voltage type auto charge pump and the double-voltage rectifier circuit can partially separate the inductance values of the first inductor L1 and the second inductor L2 of the energy storage element in the circuit as the resonant inductor L3, and constitute the L3C1 resonant circuit by coupling the third inductor L3 with the first capacitor C1 in parallel. The circuit architectures are shown in FIG. 1A through FIG. 1G. 2G. In addition, by means of the design of parameters and the action of the LC resonant circuit, the circuit is made to have the characteristics of variable circuit architecture. In cooperation with the second capacitor C2, an in-series resonant in-parallel load circuit is constituted to achieve the effect of high step-up ratio. The output voltage can be further increased by means of the double-voltage rectifier circuit at the secondary side of the transformer. Furthermore, by means of the integration of the LC resonant circuit with the active switching elements and the design of the parameters, it can achieve the soft switching technique to reduce any switching loss and electric magnetic interruption (EMI). Compared to the conventional circuit in terms of functions, means and effect, according to the invention the integration of the dual-phase interleaved boost circuit with the voltage type auto charge pump circuit through the transformer, and the characteristics of automatically changing the circuit architecture of the voltage type auto charge pump circuit contribute to achieve the effect of soft switching for all the switching elements and high step-up ratio so as to achieve high step-up ratio, low cost, low EMI, low input current ripple and high conversion efficiency.

In summary, the present invention relates to an isolated interleaved DC converter which has integrated soft-switching technology with high voltage conversion and can effectively improve the shortcomings of conventional technology. The circuit of this invention combines the dual-phase interleaved boost circuit and the voltage type auto charge pump circuit through the transformer at the primary side of the transformer to reduce the input current ripple. At a secondary side of the transformer, the circuit of the invention further combines the double-voltage rectifier circuit. By means of the design of circuit parameters and the action of the LC resonant circuit make the circuit have characteristics of variable circuit architecture, and achieve the effect of soft switching, high step-up ratio, low cost, low EMI, low input current ripple and high conversion efficiency. This makes the invention more progressive and more practical in use which complies with the patent law.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. An isolated interleaved DC converter, used to convert a DC input voltage into a DC output voltage in order to provide a load with power supply, comprising:
a front-end conversion circuit, comprising a dual-phase interleaved boost circuit and a voltage-type auto charge pump circuit, wherein the dual-phase interleaved boost circuit is provided with a negative voltage terminal at an input side respectively coupling to a first active switching element and a second active switching element in parallel, a positive voltage terminal at the input side respectively coupling to a first inductor and a second inductor in parallel, and wherein the first active switching element and the first inductor which is coupled to the first active switching element in series are coupled in series to a semi-resonant circuit of the voltage-type auto charge pump circuit; the semi-resonant circuit is coupled to one common node between the first active switching element and the first inductor and includes a third inductor and a first capacitor coupled to the third inductor in parallel; the voltage-type auto charge pump circuit further includes a second capacitor coupled in series to the semi-resonant circuit; and the second capacitor is coupled in parallel to a common node between the second active switching element and the second inductor; and
a transformer, wherein a primary side of the transformer is coupled to the front-end conversion circuit and to the second capacitor in parallel, a secondary side of the transformer is coupled to a rear-end conversion circuit which is electrically coupled with the front-end conversion circuit through the transformer.

2. The isolated interleaved DC converter of claim 1, wherein the secondary side of the transformer is coupled with the rear-end conversion circuit which is a full-bridge rectifier circuit constituted by four diodes and a capacitor.

3. The isolated interleaved DC converter of claim 1, wherein the secondary side of the transformer is coupled with the rear-end conversion circuit which is a double-voltage rectifier circuit constituted by two diodes and two capacitors.

4. The isolated interleaved DC converter of claim 1, wherein the transformer is a multi-winding transformer, and the secondary side of the transformer is coupled with the rear-end conversion circuit which is a rectifier circuit constituted by two diodes and one capacitor.

5. The isolated interleaved DC converter of claim 1, wherein the transformer is a multi-winding transformer, and the secondary side of the transformer is coupled with the rear-end conversion circuit which is a triple-voltage rectifier circuit constituted by four diodes and three capacitors.

6. The isolated interleaved DC converter of claim 1, wherein the transformer is a multi-winding transformer, and the secondary side of the transformer is coupled with the rear-end conversion circuit which is a four times-voltage rectifier circuit constituted by four diodes and four capacitors.

7. The isolated interleaved DC converter of claim 1, wherein the transformer is a multi-winding transformer, and the secondary side of the transformer is coupled with the rear-end conversion circuit which is a five times-voltage rectifier circuit constituted by six diodes and five capacitors.

8. The isolated interleaved DC converter of claim 1, wherein the transformer is a multi-winding transformer, and the secondary side of the transformer is coupled with the rear-end conversion circuit which is a six times-voltage rectifier circuit constituted by six diodes and six capacitors.
